(19) United States
(12) Patent Application Publication
(10) Pub. No.: US 2010/0304200 A1
(43) Pub. Date: Dec. 2, 2010

(54) ELECTRONIC DEVICE WITH BACK-UP POWER DURING BATTERY REPLACEMENT

(75) Inventor: JIN-SHI LAI, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/540,346

(22) Filed: Aug. 12, 2009

(30) Foreign Application Priority Data
May 27, 2009 (CN) 200910302674.6

(51) Int. Cl. H01M 2/10

(52) U.S. Cl. 429/99

(57) ABSTRACT

The present invention provides an electronic device having reserve power during battery replacement. The electronic device includes a body and a printed circuit board (PCB) mounted in the body. The body defines an accommodating space. At least two pairs of electric joint elements are fitted on the PCB. The accommodating space is configured to accommodate a first battery. At least one pair of electric joint elements is engaged with the battery. Each of the at least two pairs of electric joint elements is aligned in parallel to each other. When the first battery is replaced by a second battery, a first pair of the electric joint elements is kept engaged with the first battery and a second pair of the electric joint elements is engaged with the second battery.

### BACKGROUND

1. Technical Field

The disclosure relates to an electronic device and, more particularly, to an electronic device having reserve power during battery replacement.

2. Description of the Related Art

Electronic apparatuses, such as mobile phones, run on battery power. When a battery runs low and the user decides to replace the battery with another one rather than using a charger, then the apparatus must be powered off, which may result in data loss.

### BRIEF DESCRIPTION OF THE DRAWINGS

The components in the drawings are not necessarily drawn to scale, the emphasis instead being placed upon clearly illustrating the principles of the electronic device. Moreover, in the drawings, like reference numerals designate corresponding parts throughout the several views.

FIG. 1 is an exploded, perspective view of an electronic device in accordance with an embodiment.

FIG. 2 is an schematic view of a battery of the device of FIG. 1.

FIG. 3 is an enlarged view of the encircled portion III of FIG. 1.

FIG. 4 is an enlarged view of the encircled portion IV of FIG. 1.

FIG. 5 is a perspective view of the battery of FIG. 2 connected to the electronic device of FIG. 1.

FIG. 6 is similar to FIG. 5 but including a replacement battery.

FIG. 7 is similar to FIG. 6 but with the battery of FIG. 2 removed.

### DETAILED DESCRIPTION

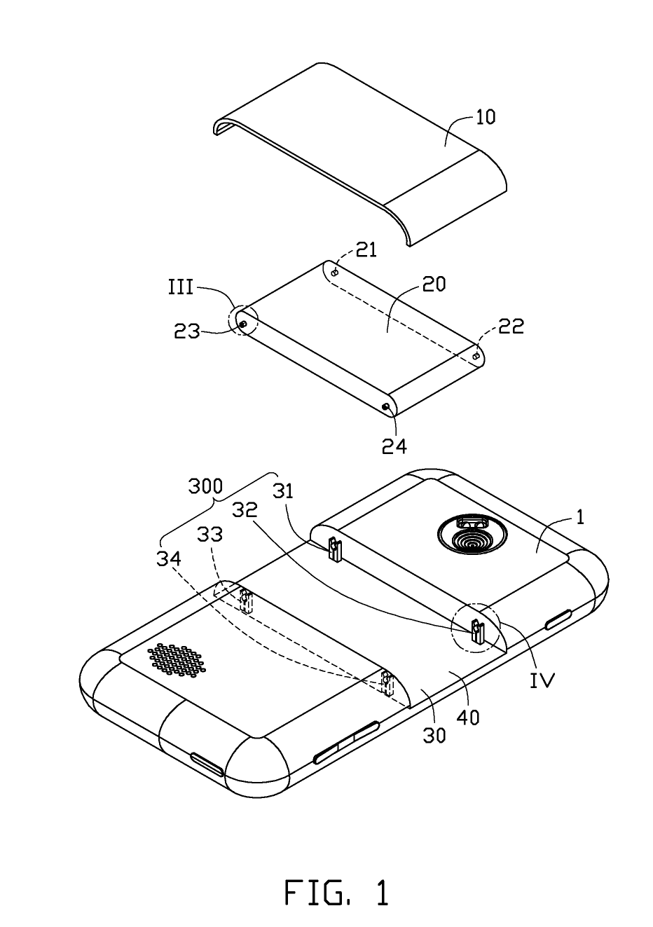

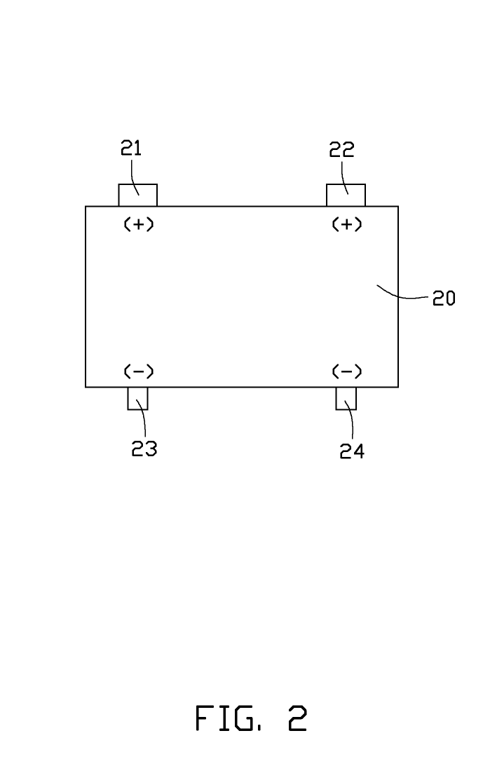

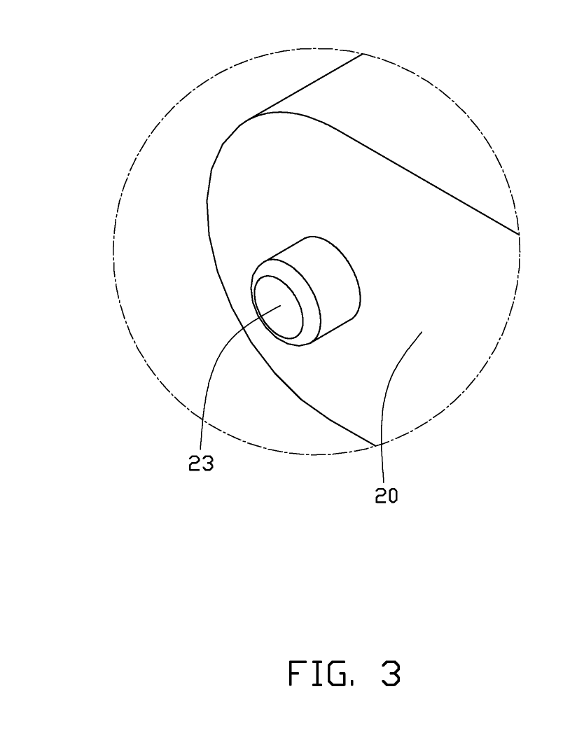

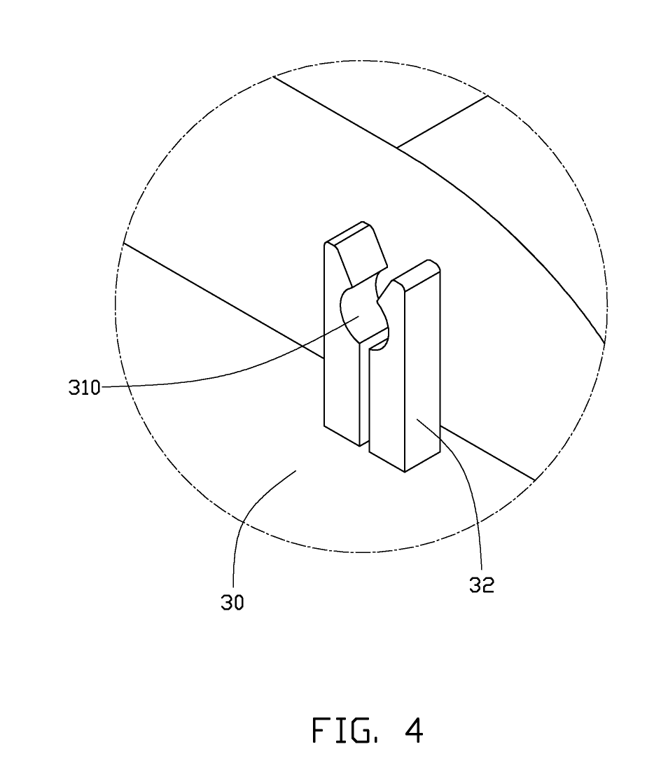

Referring to FIGS. 1-4, an electronic device employs a battery as a power source. For illustrative purposes, a mobile phone is used as an example. The mobile phone includes a body 1, a cover 10, and a printed circuit board (PCB) 30 mounted in the body 1. An accommodating space 40 is defined in the body 1 and is configured to accommodate a battery 20. The cover 10 covers the accommodating space 40 so as to cover the battery 20.

At least two pairs of electric joint elements 300 are fitted on the PCB 30. The elements 300 of each pair of the at least two pairs of electric joint elements 300 are aligned in parallel to each other. At least one pair of electric joint elements 300 is engaged with the battery 20. In this embodiment, the PCB 30 has two pairs of electric joint elements 300 fitted thereon. The two pairs of electric joint elements 300 include a pair of elastic slots 31 and 33, and a pair of elastic slots 32 and 34. The pair of elastic slots 31, 33 and the pair of elastic slots 32, 34 are aligned in parallel. Each elastic slot is composed of conductive material, such as copper. Two pairs of elastic slots are engaged with the battery 20.

In this embodiment, each elastic slot has a circular hollow part 310, a diameter of the hollow part of the elastic slot 31 is equal to a diameter of the hollow part the elastic slot 32, and a diameter of the hollow part of the elastic slot 33 is equal to a diameter of the hollow part of the elastic slot 34. The diameter of the hollow part of the elastic slot 31 or 32 is different from the diameter of the hollow part of the elastic slot 33 or 34. For example, the diameters of the hollow parts of the elastic slots 31, 32 are 1.5 millimeters and the diameters of the hollow parts of the elastic slots 33, 34 are 1 millimeter. In another embodiment, all the elastic slots 31, 32, 33, 34 are the same.

The battery 20 has at least two pairs of electrodes. In this embodiment, an anode 21 and a cathode 23 are adjacent to side of the battery 20, and an anode 22 and a cathode 24 are adjacent to an opposite side of the battery 20. The two pairs of electrodes are connected in parallel and provide the same voltage. Each electrode is a cylindrical protrusion. Each protrusion is composed of conductive material such as copper.

Diameters of the cylindrical protrusions of the anodes 21, 22 are equal to the diameters of the hollow parts of the elastic slots 31, 32. Diameters of the cylindrical protrusions of the cathodes 23, 24 are equal to the diameters of the hollow parts of the elastic slots 33, 34. Therefore, a user can easily distinguish the anode and the cathode of the battery 20. Each pair of the cylindrical protrusions of the anode and the cathode can be engaged with each pair of the hollow parts of the elastic slots and rotate relative to each pair of the elastic slots.

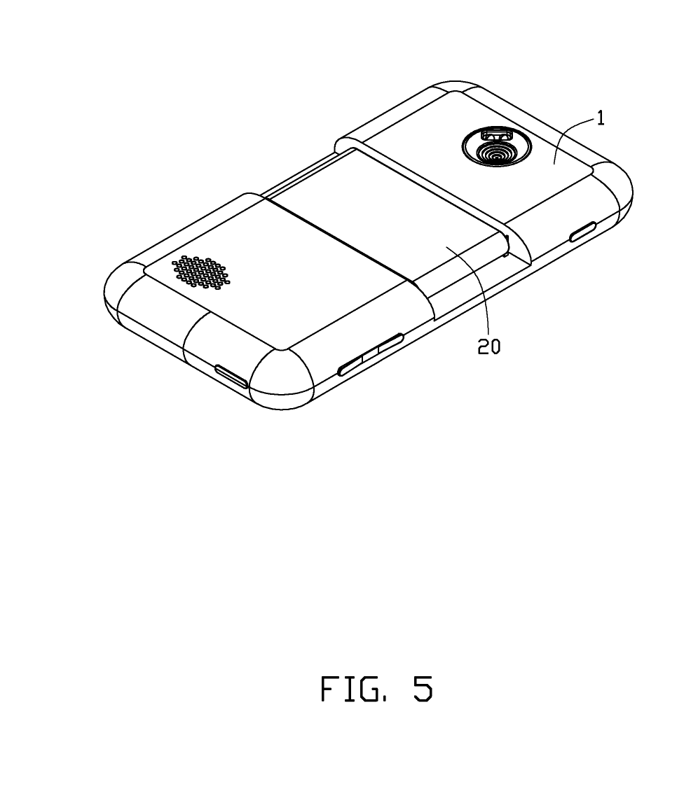

When the battery 20 is inserted into the accommodating space 40, the anode 21 of the battery 20 is engaged with the elastic slot 31 or 32 and the cathode 23 of the battery 20 is engaged with the elastic slot 33 or 34. As shown in FIG. 5, the battery 20 is inserted into the accommodating space 40 of the mobile phone, and the anodes 21,22 and the cathodes 23,24 are engaged with the corresponding elastic slots 31-34, and thereby, the battery 20 supplies power for the mobile phone.

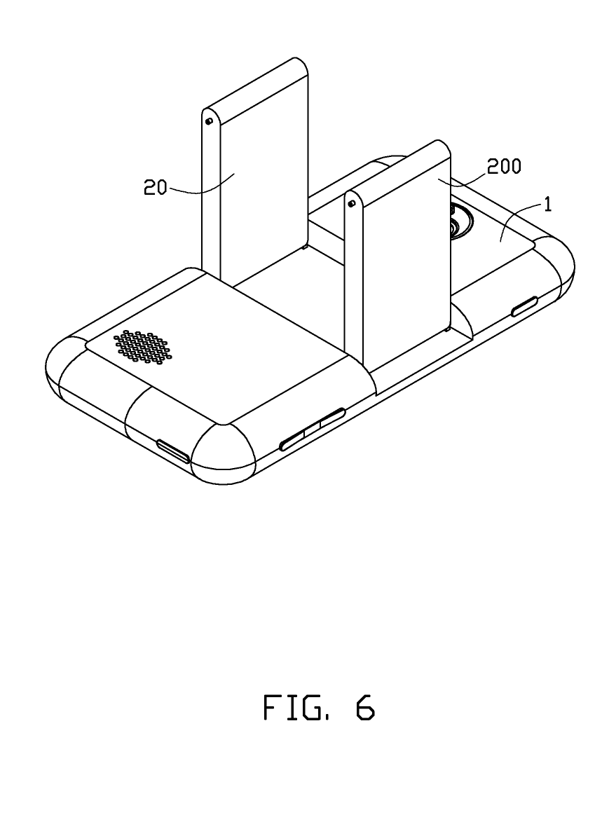

As shown in FIG. 6, when the battery 20 is to be replaced with another battery 200, the battery 20 is rotated so that one of the anode and cathode pair 21, 23 are maintained in their elastic slots 31, 33 and an anode and cathode pair of the battery 200 is engaged with the vacated elastic slots 32, 34. At this point the batteries 20, 200 are connected to the mobile phone in parallel and jointly supply power.

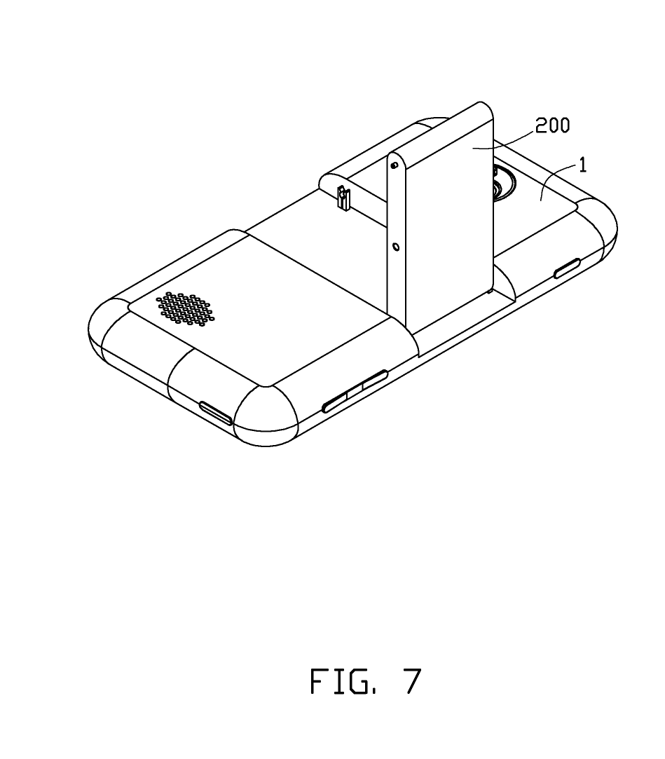

As shown in FIG. 7, the battery 20 can then be detached and removed from the accommodating space 40, and the battery 200 can then be rotated into the accommodating space 40 and become sole source of power for the mobile phone. Therefore, the mobile phone remains powered on even while the battery is being replaced.

In another embodiment, each pair of electric joint elements of the PCB is a pair of cylindrical protrusions. Each pair of anode and cathode of the battery is a pair of elastic slots. The protrusions and the elastic slots are composed of conductive material. Each pair of the elastic slots of the battery is engaged with a corresponding pair of protrusions of the PCB.

It is understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An electronic device comprising:
a body defining an accommodating space;
a printed circuit board (PCB) mounted in the body; and
at least two pairs of electric joint elements fitted on the PCB;
wherein the accommodating space is configured to accommodate a first battery, at least one pair of electric joint elements is engaged with the first battery, each of the at least two pairs of electric joint elements is aligned in parallel to each other, when the first battery is replaced by a second battery, a first pair of the electric joint elements is kept engaged with the first battery and a second pair of the electric joint elements is engaged with the second battery.

2. The electronic device as recited in claim 1, wherein each pair of the electric joint elements of the PCB is a pair of elastic slots.

3. The electronic device as recited in claim 2, wherein each elastic slot has a circular hollow part, the two diameters of the hollow parts of a pair of the elastic slots are different, and the diameters of the corresponding hollow parts in each pair of the elastic slots are equal.

4. The electronic device as recited in claim 2, wherein each elastic slot is composed of conductive material.

5. The electronic device as recited in claim 1, wherein each pair of electric joint elements of the PCB is a pair of cylindrical protrusions, and at least one pair of protrusions is engaged with the battery.

6. The electronic device as recited in claim 5, wherein the two diameters of a pair of the protrusions are different, and the diameters of each pair of the protrusions are equal.

7. The electronic device as recited in claim 5, wherein each cylindrical protrusion is composed of conductive material.
